(19) United States
(12) Patent Application Publication
(10) Pub. No.: US 2009/0006608 A1
(43) Pub. Date: Jan. 1, 2009

(54) DYNAMICALLY ENHANCING MEETING PARTICIPATION THROUGH COMPILATION OF DATA

(75) Inventors: Anoop Gupta, Woodinville, WA (US); Bruce Johnson, Woodinville, WA (US); Paul J. Hough, North Bend, WA (US); Mary P. Czerwinski, Woodinville, WA (US); Pavel Curtis, Bellevue, WA (US); Richard J. McAniff, Bellevue, WA (US); Raymond E. Ozzie, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/770,601

(22) Filed: Jun. 28, 2007

(51) Int. Cl. G06F 15/173

(52) U.S. Cl. 709/224

(57) ABSTRACT

Meeting attendees can have the resources available to participate in an efficient meeting regardless of where the attendees are located (e.g., across from each other or thousands of miles apart). Information can be gathered that relates to the attendees, the subject matter of the meeting or other information. In addition, relationships between attendees, if any, can be determined and displayed to the attendees to show the interrelatedness of the group. Various aspects during the meeting can also be observed and analyzed to allow the attendees to become more aware of the dynamics between individuals as well as the entire team.

### BACKGROUND

Computing devices can be accessed at almost any time and any place and can contain a tremendous amount of information relating to people, organizations, general interests etc. In fact, many people choose to share information about themselves with others, such as through a social network or through a journal. Such information can include thoughts, interests, photos, and anything else someone wants to share. In addition, organizations retain information relating to an organizational hierarchy, job titles and descriptions, as well as information relating to each employee, projects, competitors and so forth.

In various organizations today, there is a tremendous amount of time spent preparing for meetings and attending those meetings as well as other tasks related to meetings (e.g., action items). Sometimes meetings can be productive and worthwhile for both the participant and the organization. However, sometimes the meeting is not productive due to various factors including the situation when the participants do not know each other and might be hesitant to participate or offer information since there is no familiarity with the other participants. This can especially be true when one or more participants are remote from the meeting place (e.g., meeting is conducted over the phone). In some situations, the meeting might not be as productive as it should be because the needed information is not readily available.

Meetings should allow participants the opportunity to achieve common goals while mitigating the amount of wasted time, regardless if the attendees are sitting around a table or around the country. In addition, meetings should be more than merely isolated events but should be a piece of an overall collaborative framework or organizational goal. Further, attendees should have access to the most accurate, up-to-date information in order to help them perform at a high level of efficiency.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with increasing productivity, diversity and communications among individuals. Data (e.g., visual, audio) can be presented to people that are engaged in communication (e.g., meeting, conversation) in order to promote better and more meaningful interaction. The data can include background information, relationships, commonality and other information that can allow those communicating to know something about each other, which can make communications more productive.

During a meeting, the various gestures, behaviors and interactions of the participants can be observed. An indication of various barriers to effective communication observed can be communicated (e.g., displayed) to the meeting participants and can be corrected. For example, if one person is dominating the conversation a flag or indicator might be presented to the group (or just the offender). In such a manner, the person might realize what he is doing and give another person the ability to speak.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates an example system that dynamically collects meeting information and provides an indication of the interrelatedness of such information.

FIG. 2 illustrates another example system that compiles data relating to project dynamics and selectively disseminates the data to increase an entity's project contributions.

FIG. 3 illustrates another example system that facilitates interaction and collaboration between two or more individuals.

FIG. 4 illustrates an example meeting model that can be presented in accordance with the one or more aspects disclosed herein.

FIG. 5 illustrates an example system that facilitates meeting participation by observance of behaviors.

FIG. 6 illustrates an example of a system that can increase meeting participation through real-time feedback.

FIG. 7 illustrates a method for increasing meeting participation through compilation of data.

FIG. 8 illustrates a method for dynamically increasing meeting interaction through real-time feedback.

FIG. 9 illustrates a block diagram of a computer operable to execute the disclosed aspects.

FIG. 10 illustrates a schematic block diagram of an exemplary computing environment operable to execute the disclosed aspects.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

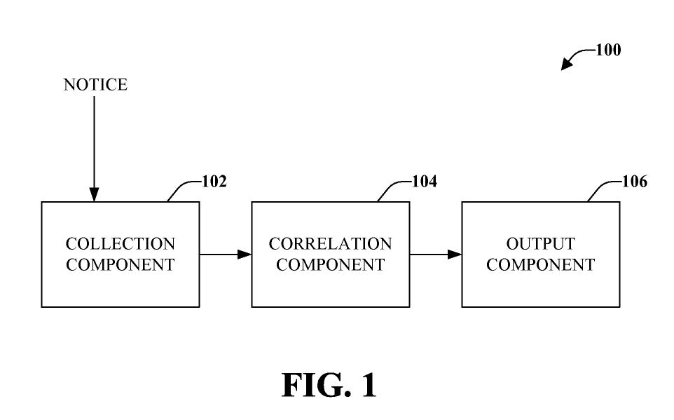

Referring initially to FIG. 1, illustrated is an example system 100 that dynamically collects meeting information and provides an indication of the interrelatedness of such information. Generally, individuals spend time in meetings on a daily basis and such time spent might not be as productive as the individual would like. Over the course of a year, the time spent in meetings can add up to hundreds, if not thousands of hours for a single individual. System 100 can be configured to dynamically enhance meeting participation and efficiency through visual data or data presented in audio or other formats. To facilitate such participation and efficiency, system 100 can be configured to provide various information relating to participants of a meeting, conference or other scenario where two or more people meet (e.g., physically, virtually) to discuss a common topic. System 100 can also provide information relating to the topic of the conversation (e.g., who else should be included) as well as information relating to associated or ancillary topics and/or other topics that might be of interest to the participants. It should be understood that although the various examples and aspects are be shown and described with reference to an organization, they apply equally well to situations outside an organization where two or more people engage in a joint effort.

In further detail, system 100 includes a collection component 102 that can be configured to receive a notice or other indication that two or more people will be getting together to discuss something. The notice can be a listing of participants (e.g., names, email aliases, extension numbers, and so forth), such as from a meeting request or agenda. In accordance with some aspects, the notice can be a telephone call initiation whereby one person dials a telephone number to call another person that might be known or unknown to the person initiating the telephone call. The notice can also include a topic to be discussed by the participants.

Collection component 102 can obtain information relating to the participants and/or the topic. Information relating to the participants can include information that is generally known (e.g., job title, department, supervisor, subordinates, current projects, picture, and so forth). The information might also be not generally known but information that an individual desires others to know (e.g., interests, hobbies and the like). Other personal information can include email, pictures, videos and so forth. Information relating to the topic can include reports, papers, etc. related to the topic or authored by a participant, documents shared between participants, names of other people that might have knowledge of the topic and so on. Information can also relate to an organization (e.g., sales reports, topic experts, and so on) and/or public information (e.g., news, blogs, maps, and so forth).

The gathered information can be communicated to a correlation component 104 that can be configured to determine relationships, such as a common relationship, between the participants or between other information compiled by collection component 102. For example, correlation component 104 can show links between participants, such as if one participant reports to another or if two or more report to the same supervisor. Other links can include papers co-authored, other projects in which two or more participants were involved, or other links between the various types of information gathered by collection component 102.

The information and associated relationships, if any, can be output, upon request, to the meeting participants or other individuals authorized to view such information. Such information can be presented by output component 106, which can be configured to present the information in a variety of formats (e.g., visual, audio). The information can be provided before, during or after the meeting. For example, an individual might be preparing for the meeting and desire to know who else will be attending. The various meeting participants can be presented as well as the relationship between those participants and the individual requesting the information. As such, the individual might realize that one of the other participants is working on an unrelated project but there is information that they need to share (e.g., documents, a brief discussion). By reviewing the information before the meeting, it can be determined that time can be saved (e.g., increased efficiency) by bringing the documents to the scheduled meeting or having a brief conversation after the scheduled meeting rather than having to initiate another conversation at a different time.

In accordance with another example, information might be presented based upon a user query, such as a request for all meetings that became increasingly louder over time. One or more meetings can be presented based upon the query as a function of a time encoded with the recorded meeting and, as time associated with a meeting progresses, the volume of the meeting can be analyzed to determine the meetings that satisfy the query.

The gathering of information and the determination of interrelatedness of the information can be ongoing and dynamically updated by system 100. That is to say, the information initially gathered and analyzed can be dynamically changed over time. Thus, if a particular project is on going, as new participants are added and/or as participants are deleted, the information can be automatically updated. For example, new information might be posted to a person's profile page and this information can be compiled and output upon request. As participants are added or deleted, the interrelationship between the various participants might change and system 100 can automatically update the visual linking of participants and/or other information.

In accordance with some aspects, information presented or discussed at the scheduled meeting can be dynamically applied to an individual's profile or a profile of the meeting. Thus, if there is a question about an item discussed, action items generated, or the like, the individual that presented the item can be readily determined. As such, system 100 can transform a meeting into a vivacious entity that is more than merely a discussion of a common topic but instead is an on-going, dynamic network of contributions and resources that can be selectively exposed and utilized.

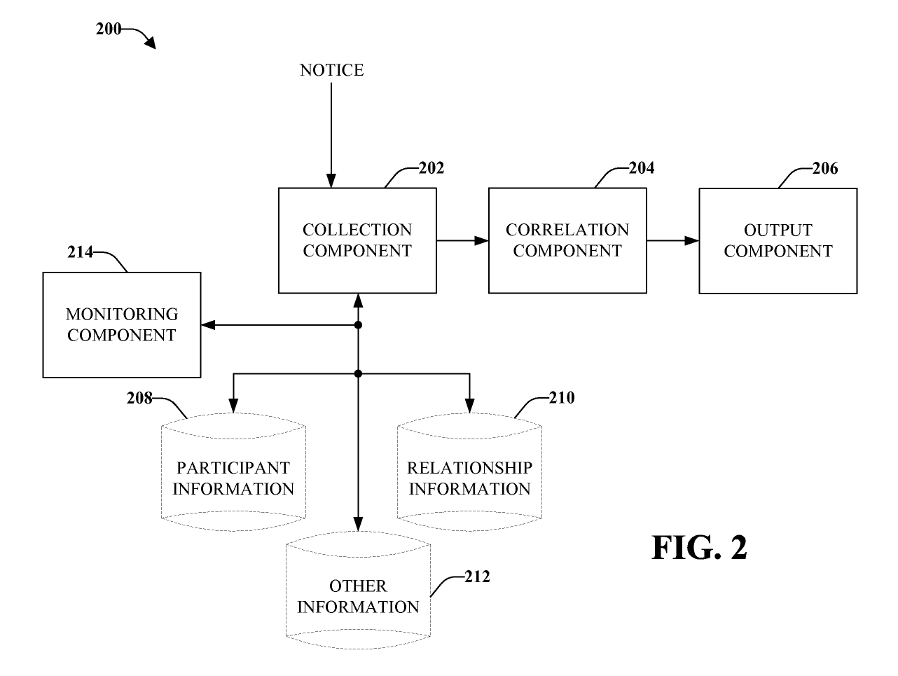

FIG. 2 illustrates another example system 200 that compiles data relating to project dynamics and selectively disseminates the data to increase an entity's project contributions. Various factors can have a direct or indirect influence on the success or failure of a project. Such factors include the entities involved, the knowledge that is known or can be obtained, the amount of communication or interaction among the entities, as well as other factors. If one or more factors are not working at a certain level of efficiency, it can have an influence on other factors and on the project as a whole. Similarly, if one or more factors are achieving a high level of success, the overall project itself can be successful and become a model for other projects. System 200 can attempt to make the most of parameters relating to each factor that can have a positive influence on overall project.

System 200 can include a collection component 202 that can obtain data relating to one or more meeting (e.g., interactions between two or more entities) or project parameters. Collection component 202 can automatically begin to gather the data when an indication of the meeting is received. In accordance with some aspects, collection component 202 does not gather the data until receiving an instruction from a user and/or entity. The data can be directly on point or can have an ancillary influence on the meeting parameters and can be obtained from an unlimited number of sources. The various data obtained can be linked together by correlation component 204 that can provide such linking based on the data obtained or on other knowledge sources. The data and any links between the data can be communicated to an entity (e.g., a user, a participant, the Internet, another system, a computer and so forth) through interaction with output component 206, which can selectively present the gathered information and the common relationship.

In more detail, collection 202 component can acquire data from one or more repositories of information. A first repository 208 can obtain and/or maintain information relating to project participants. For example, first repository 208 can include information maintained by a Human Resources Department and/or other departments of an organization. The information maintained by first repository 208 can include names of individuals, job titles, job descriptions, responsibilities, and so on. The information can further include projects worked on (current, past or future), knowledge base (e.g., education, employment history, specialties, and so on) as well as other types of information.

First repository 208 can further maintain or access personal information that an individual might want others to know (e.g., make public). Such information can include personal interests (e.g., leisure, work-related), close contacts or friends, projects that would interest/not interest the individual, and so on. This information can also include a personal journal, diary or other record (e.g., webblog, blog, and the like), which an individual updates from time to time and can include activities, thoughts, pictures or anything else the individual wants to share with specific individuals or with everyone (e.g., publicly available).

A second repository 210 can be configured to obtain and/or maintain information that relates to various interactions between individuals. Such information can be updated or maintained by various departments and can include a reporting structure or organizational hierarchy that corresponds each individual with a supervisor, co-worker, peer or subordinate. Other information can include social network information that can be compiled by the individual or automatically compiled (at least in part) by system 200 through monitoring and collection of interactions (e.g., email, phone calls, meeting participation and other activities).

A third repository 212 can be configured to obtain and/or maintain information that relates to either the participants, relationships, project, or other information that can be useful to increase project dynamics and interaction among the participants. For example, a person might maintain a listing of the books, articles, papers, etc. read and provide comments about the items in the listing. While three repositories 208, 210, 212 are shown and described, it should be understood that fewer or more repositories could be utilized with the various aspects disclosed herein.

System 200 can further include a monitoring component 214 that can observe and/or record various actions in real-time (e.g., actual or relative). For example, monitoring component 214 can observe actions of each individual and/or interactions between two or more individuals (e.g., discussions, phone calls, email messages, text messages, documents viewed, documents modified, and so on), activities and discussions in meetings and so forth. Various types of transactions can be tracked and/or imbedded together. A time (e.g., actual or relative) can be encoded in conjunction with recorded events. For example, a telephone call that is initiated in response to an email can be connected together (e.g., as a single thread) based on capturing such information as a single unit, regardless of the form of communication or if there are multiple forms. Monitoring component 214 might run in the background observing what the user is doing, who they are communication with, who they send common mail to, the threads of the email, and so forth. Such observation and collection can, therefore be ongoing.

The information observed by monitoring component 214 can be selectively communicated to collection component 202 and/or repositories 208, 210, 212 and/or other forms of storage. Such selective inclusion of information can take into account privacy concerns. For example, monitoring component 214 might observe some activities and make a determination that such activities are private and not forward such activities for collection. In other situations, a prompt or question can be posed to the various individuals asking whether such information should be stored, which allows the individual to control the content available to others. In accordance with some aspects, a user can indicate certain information (e.g., such as in a profile page) as being either authorized or not authorized to be shared with others. If the information is not authorized, it is ignored by system 200 and not included in the collected information. As data is observed and compiled, correlation component 204 can update the relationships between project participants and related information.

Repositories 208, 210, 212 can be memory and/or some other medium that can store information. By way of example, and not limitation, the repositories 208, 210, 212 can include nonvolatile and/or volatile memory. Suitable nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of example and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

System 200 can provide participants of a project with information that can increase the dynamics of the participants and the success of the project. Additionally or alternatively, system 200 can facilitate selection of individuals that should be included in a particular project. By way of example and not limitation, a person might be overseeing a stated project (e.g., business objective) and needs to create a team responsible for researching and implementing various aspects relating to the project. A sample team or model can be organized by interacting with system 200 and adding people to the sample team. System 200 can gather information relating to various individuals and illustrate relationships between such individuals. Based in part on the presented information, a determination can be made whether the individuals included in the sample team are appropriate or whether one or more changes should be made. As changes are made, system 200 can dynamically update the participant information and links or relationships between the individuals. As such, system 200 can be utilized as a tool, not only by the participants themselves but also in constructing teams for various projects whereby personal and organization productivity can be increased.

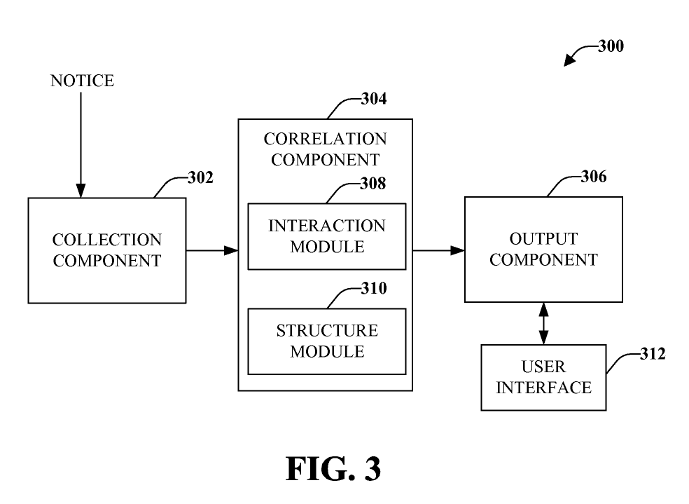

With reference now to FIG. 3, illustrated is another example system 300 that facilitates interaction and collaboration between two or more individuals. Many times individuals that need to interact (e.g., meeting setting or other discussions) might not know anything about each other. In the case of meetings, such lack of awareness of the other participants might intimidate a person, which can decrease that person's participation and contributions to the meeting until more is known about the other participants (e.g., after a few meetings). This lack of knowledge about others can decrease the effectiveness of the meeting. Therefore, system 300 can provide information about others that should aid in increasing interaction between the participants. Such information can be reviewed before, during or after a meeting and can be dynamically updated as more information is learned about various individuals, when information is corrected, or based on other inputs (e.g., activities, posting on personal social networks and so forth).

To facilitate interaction and collaboration, system 300 can include a collection component 302 that receives an indication or notice that two or more people need to interact. The indication can be a phone call initiation, a received phone call, meeting notice and so on. In accordance with some aspects, the indication is based on a location of two of more people, thus the location or proximity of people can indicate that a conversation between those people is occurring. Information relating the people, subject matter of a conversation or meeting and so forth can be accessed and brought together by collection component 302. A correlation component 304 can be configured to determine and establish visual (or through other perceivable means) relationships between the people or other information that might be relevant to increasing communications, which can be perceived by the use through interaction with output component 306.

Correlation component 304 can include an interaction module 308 that can be configured to evaluate the information relating to the various attendees. For example, interaction module 308 can evaluate one or more demographics of the meeting participants and create a linking or relationship between the participants based in part on the demographics. Interaction module 308 can also evaluate other information based on key words, phases and so forth that are included in the information for each individual. For example, key phrases can include “information worker” and “global connectivity.” Two participants might have these two phases in the information associated with them and linking can occur between the two participants based on these key phrases. Other linking can occur through inference of other similarities between two or more individuals (e.g., past projects worked on, educational background, professional experience, likes/dislikes, and so on).

A structure module 310 can be configured to create a model or other representation of the links or relationship between the participants. The model or structure of the meeting can include a visual representation of the participants to each other. A picture of each person can be chosen and placed in a particular location within the model to facilitate ease in understanding a hierarchy of the participants to each other and/or a relative position within an organization.

In accordance with some aspects, the model can be altered or modified based on information received manually. For example, a questionnaire can be posed to the participants to determine further information that would be helpful to illustrate relationships or if more information is necessary. The questionnaire can request information relating to whether a person has an association with another person in the meeting (e.g., business, personal, and so on) or a variety of other information. The questionnaire might be presented to a participant in the meeting that is new to the organization, a sub-contractor, a non-employee that is working on the project (e.g., collaboration of two or more organizations) and so forth. Thus, further information can be solicited to present a more accurate model of the meeting participants. However, issues of privacy should be taken into account when such information is solicited and/or allowed to be viewed by others.

The created model can be presented to a user through output component 306, which can be associated with a user interface 312 that can allow an individual to interact with system 300. It should be understood that user interface 312 could be associated with other system components. User interface 312 can provide a graphical user interface (GUI), a command line interface, a speech interface, Natural Language text interface, and the like. For example, a GUI can be rendered that provides a user with a region or means to load, import, select, read, etc. various information that should be included in the analysis performed by system 300, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

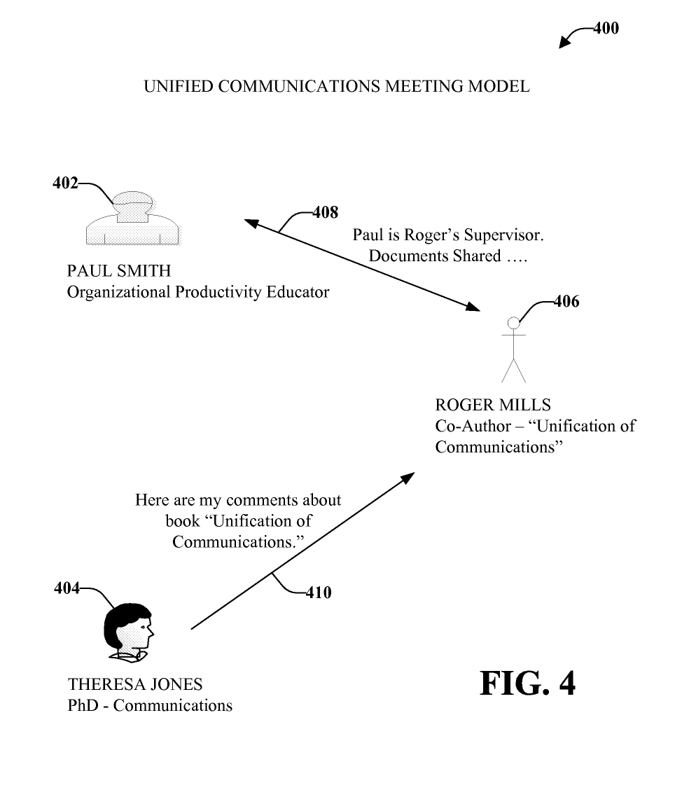

An illustration of an example model 400 that can be presented is illustrated in FIG. 4. This is a simple example of three participants 402, 404, 406 in a meeting or other interaction. Upon receiving a request, the model 400 can be displayed so that information about others can be learned. Each participant in the meeting can be represented in the model 400 as a picture of the person. As illustrated, the name and some information about the participants can be included below their respective pictures. However, in accordance with some aspects, the picture of the participant is “clicked on” or selected (e.g., voice command or selected in another manner) in order to view further information about that particular person.

For example, participant 402 is listed as “Paul Smith” with a title of “Organizational Productivity Educator.” A second participant 404 can be “Theresa Jones” who has a PhD in Communications. A third participant 406 is listed as “Roger Mills” and indicates he is a Co-Author of the book “Unification of Communications.” A link or relationship 408 between “Paul Smith” 402 and “Roger Mills” 406 indicates that Paul is Roger's supervisor. As illustrated, the relevant linking information can be displayed automatically or it might not be displayed until the link is selected and/or a participant is selected. A second link or relationship 410 indicates that Theresa 404 has read the book by Roger 406 and has commented on the book. Such comments can be included, for example, on Theresa's blog or other social network.

There can be further relationships than those illustrated; however, considerations such as display screen size, amount of content on a display screen as well as other factors can be taken into consideration when it is determined how to present information. As illustrated, there is no connection or link between Paul 402 and Theresa 404. However, by accessing the model, the participants can be aware of their relationship with others (if any) as well as the relationship between the other participants (if any). Thus, a common ground between the participants in the illustrated model 400 can be the book and since the meeting is indicated as relating to Unified Communications, the book can be a starting point for facilitating interactions. Therefore, the interaction and dynamics between the meeting participants can be enhanced by knowing something about each other.

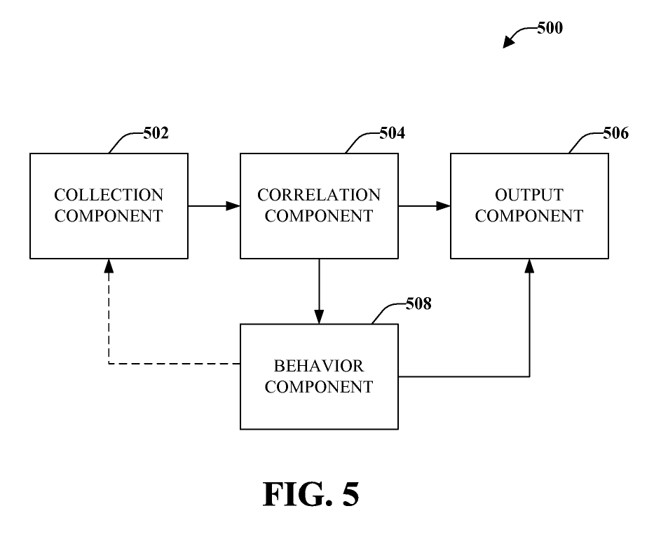

FIG. 5 illustrates an example system 500 that facilitates meeting participation by observance of behaviors. System 500 is similar to the systems described with reference to the above figures and includes a collection component 502 that collects information, a correlation component 504 that determines an interrelationship between the information, and an output component 506 that presents the results to a user. However, system 500 can further be configured to attempt to increase meeting participation by observing various behaviors exhibited by the participants during the meeting and providing an interpretation of the behaviors.

To observe such meeting dynamics, a behavior component 508 can be configured to observe, record and/or analyze the various behaviors and the interaction between participants. For example, behavior component 508 can observe and determine whether a particular person is speaking based on various behaviors such as whether a person is standing or sitting, movement of hands, others looking at a particular person and other indications that someone is talking. Behavior component 508 can include, but is not limited to, high-resolution video, gaze perception, speaker tracking and intelligent/automated camera management, and so on.

In accordance with some aspects, one or more participants are located off-site and interact in the meeting through a telephone, video conferencing or other means. In this situation, separate behavior components 508 or other forms of monitoring can be located at the remote site to capture what is occurring remotely.

Other behaviors can indicate whether the participants are interested in the conversation. For example, behavior module 508 might observe a person staring off into space (e.g., indicated by not looking at someone else, looking in the same direction for longer than a predetermined amount of time, and so on), which might indicate that the person is not interested in what is going on. Other behavior might be looking down, such as reading documents or performing another function, for longer than a predetermined amount of time. Behavior module 508 might also observe more than one conversation occurring at substantially the same time, which might indicate that the participants are not interacting as a collaborative unit or that something else is occurring.

According to some aspects, behavior module 508 can listen or hear one or more conversation and record such conversations. The conversations recorded can be transferred to collection component 502 for inclusion in a meeting model based on key words, phrases, the person speaking and so forth.

If the observed behaviors indicate that one individual is contributing more content than the others, or someone is not offering any input, or other disruptive behaviors, output component 506 can present the results to the group. For example, an indication might be given that a particular person is dominating the group. This indication might invoke others to contribute or might notify the dominating person that others should be given a chance to contribute.

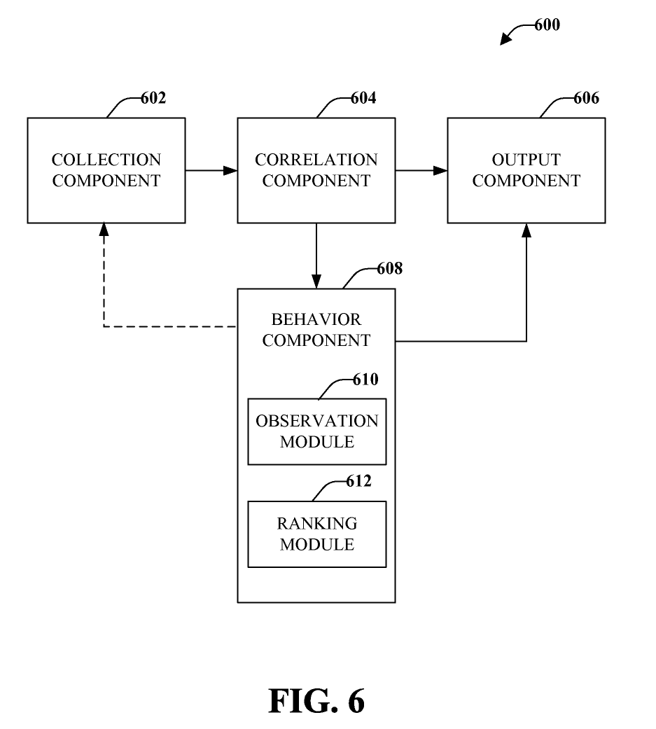

FIG. 6 illustrates an example of a system 600 that can increase meeting participation through real-time feedback. Various information relating to the meeting participants and/or the meeting are discovered and gathered by collection component 602. A correlation component 604 can be configured to construct an indication of relationships and previous interactions between the participants based in part on the gathered information (e.g., meeting model). The relationships can also be established through questionnaires or other information obtained directly from the meeting participants. The relationships and other information are presented, upon request, by output component 606. During (as well as before and after) a meeting a request can be made to receive information relating the participants. Such a request can include bringing up the meeting, such as through a meeting tag (e.g., name, code name) or other indicator of the meeting that is known by all participants and is related to that particular meeting.

During a meeting, a user can continue to view the meeting model as well as receive real-time feedback about the meeting and what is occurring. Such information can be output individually, such as on individual displays, or collectively, such as on a large screen. The real-time feedback can be provided by a behavior component 608 that includes an observation module 610 and a ranking module 612, which can gather and analyze the meeting behavior continuously throughout the meeting.

Observation module 610 can monitor each person's behavior as well as the behavior of the group as a cohesive unit. The behavior can be simply monitored or it can also be recorded for future purposes, either separately or in combination with a recording of the meeting. In accordance with some aspects, a time (e.g., actual or relative) is encoded with the recorded events and/or behaviors. Observation module 610 can be configured to distinguish each individual utilizing a face-recognition means in conjunction with a picture obtained by collection component 602 or from another source. Observation module 610 can monitor the various behaviors based on preconceived notions of what various behaviors or gestures indicate. For example, tapping on a table (e.g., fingers, pen, and the like) might indicate boredom (which might be indicated by yawning also). A person waving his arms or hands around might indicate that person is talking and is very animated about the subject of discussion.

Ranking module 612 can be configured to rank participation, interest and other indicators, such as a participant speaking followed by comments and/or applause. For example, ranking module 612 might rank the participation of each individual based on an indication of which person is talking and for how long. If a particular individual's participation is low, a low ranking (e.g., a number, a color indicator or other visual or audio information) can be associated with that individual. If participation by an individual is high, a different (high) ranking can be presented. The ranking can be a function of a respective level of contribution by each attendee as compared to the other attendees and/or the amount of feedback received (e.g., applause, comments, and so forth) after a participant contributes information. The ranking can be output to each person individually (e.g., the person only receives their ranking) or all rankings can be output to the entire group. In such a manner, persons that might be dominating the meeting can be aware of their influence on the meeting and might decide to allow others time to contribute. Alternatively, those that are not participating enough might attempt to add more content and input to the group when they realize the passiveness of their role in the meeting. In accordance with some aspects, the ranking is communicated to a source of information (e.g., a database) where the ranking and/or the transactions monitored can be updated and maintained for future purposes. The ranking can be presented as visual information of one or more formats, such as bar charts, color coding, facial representations, and so forth. In accordance with some aspects, the ranking can be presented in an audible format

At substantially the same time as the meeting behaviors are gathered and analyzed, output component 606 can present the results to one or more meeting participants. This information can also be made available after the meeting, which can allow each individual to selectively monitor their own behavior in a private manner while allowing time to concentrate on the behavior and the reasons for the behavior. Reviewing the meeting at a later time allows the participants to concentrate on the meeting and analyze behavior at a later time.

In accordance with some aspects, observation module 610 can be configured to capture information from the various devices operated by the meeting attendees. For example, some attendees might be accessing information (e.g., internal, external) and such information might be useful for others in the meeting. A collection of all the images, documents, web pages and so forth being accessed by the meeting attendees can be shown on a display screen. Such a broadcast should take into account privacy issues, however. In such a manner if someone has found information that would be useful to the group, that information can be quickly disseminated to everyone. Thus, everyone can be reviewing the same information in an attempt to increase meeting efficiency.

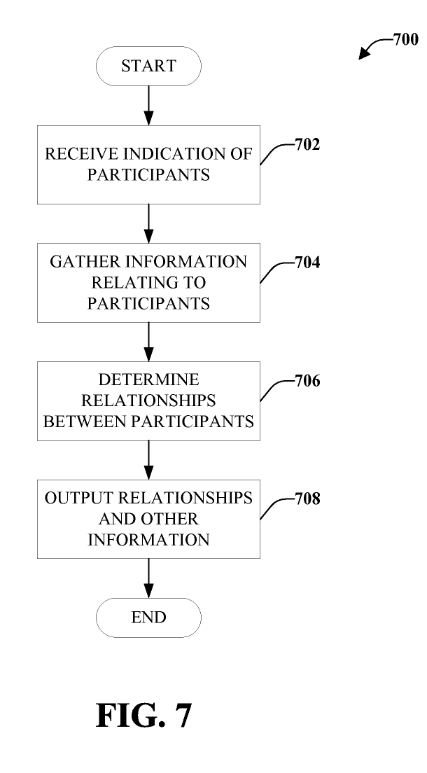

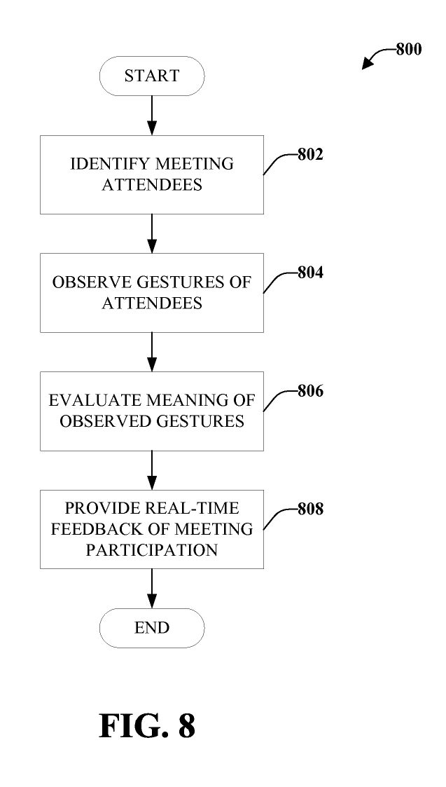

In view of the exemplary systems shown and described above, methodologies that may be implemented in accordance with the disclosed subject matter, will be better appreciated with reference to the flow charts of FIGS. 7 and 8. While, for purposes of simplicity of explanation, the methodologies are shown and described as a series of blocks, it is to be understood and appreciated that the disclosed aspects are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 7 illustrates a method 700 for increasing meeting participation through compilation of data. Collection and analysis of information relating to meeting participants can be viewed before, during or after a meeting to allow the individual participants to learn about each other. Many times, individuals invited to a meeting do not know some (or all) of the other people invited. As such, some individuals might not be aware of what they have to contribute and/or what they can learn from others. Knowing about others may also make people more comfortable sharing ideas and expressing concerns.

At 702, an indication of meeting participants is received. This indication can be in various forms including a meeting notice, email request, phone call initiation or receipt as well as in other forms. The indication might also be a sample meeting participant listing to find a best fit for individuals that should be invited to a particular meeting. The indication might be a location of two or more people near each other (e.g., a device with GPS or similar capabilities).

Information relating to the participants and/or meeting is collected, at 704. Such information can be collected from various sources including databases, repositories, personal web pages (e.g., blogs), questionnaires, direct request for information, and so forth. As the information is gathered, relationships between two or more people can be discovered, at 706. Such relationships can include a work relationship or hierarchy (e.g., supervisor, subordinate, coworker and so forth), files shared, files collaborated on, etc. Some individuals might not have a relationship with any of the other participants.

The relationship between participants (if any) and associated information relating to the relationship and or each individual is output, at 708. The information can be output upon request (e.g., clicking on a person's picture) or it can be automatically presented during the meeting. For example, if a meeting is about business intelligence, each person in the meeting might have information that is not completely pertinent to the specific meeting but collectively there is a large amount of data known by the participants that relates to business intelligence. By accessing a profile page (or similar information), other participants can click on a picture of another attendee, for example, and determine the relevant data they might have that is peripheral to the meeting but still important.

Thus, method 700 can provide meeting participants with visual (or other perceivable) data relating to various aspects of the meeting. Participants might discover facts about each other that can enhance meeting participation and productivity by finding commonalities, interests or other information about each other.

With reference now to FIG. 8, illustrated is a method 800 for dynamically increasing meeting interaction through real-time feedback. During a meeting, some people might dominate while others contribute very little content. Some attendees might incorrectly believe their participation is adequate, when in fact their participation is lower than that of the other participants. Providing real-time feedback can help to increase contributions of some people and might reduce contributions by those dominating the meeting.

Method 800 starts, at 802, when a meeting is initiated and the attendees are identified. Such identification can be based on recognizing each participant utilizing various face-recognition techniques. Other recognition can include assigned seating or knowing the position of each attendee or other techniques.

As the meeting progresses, various gestures, movements and behaviors of the attendees are observed, at 804. The various gestures and so forth can indicate what each attendee is doing during the meeting. For example, one attendee might be doing a lot of talking and is not allowing other attendees time to express their ideas. This can be observed through such gestures as excessive movement of hands, whether the person is sitting or standing, if other participants are looking at a particular attendee and so forth.

Other gestures that can be observed can indicate various other factors such as whether an attendee is paying attention (e.g., cares about the subject matter), whether there are subgroups or ancillary discussions occurring, and so forth. Such observations can indicate that the attendees are not actively involved in the meeting, which can decrease the effectiveness of the meeting.

The gestures and other indicators obtained are evaluated, at 806. Such evaluation can indicate who is speaking, how often a person is speaking, whether the contributions by a person are less than others, and other gestures or indicators. The evaluation can provide the attendees with relevant information that might help them to have a more effective meeting (e.g., regulate how often a person can speak to mitigate domination of the meeting). For example, the interactions during the meeting can be combined and productivity of the meeting tracked based in part on the combination of the interactions during the meeting. Participation from more people can also promote diversity.

At 808, the evaluation is presented to the attendees in a real-time manner. The information can be presented in any form (e.g., visual, audible). Types of visual information can include, but are not limited, to a chart (e.g., bar chart, pie chart) showing how much people are speaking or a color-coding scheme, other schemes or combinations thereof. In this way, during the meeting actions can be taken to increase participation and/or effectiveness of the attendees. During the meeting, the other participants might solicit feedback from people that have not participated as much as they should, thus increasing input by others. The information can also be viewed at a later time, which can provide an individual with feedback of their own meeting participation, which they might decide to alter in the future.

It will be appreciated that, in accordance with one or more aspects described herein, inferences can be made regarding gathering information, evaluating the gathered information, determining relationships, observing meeting dynamics and evaluating the dynamics as a function of participation. As used herein, the term to “infer” or “inference” refers generally to the process of reasoning about or inferring states of the system, environment, and/or user from a set of observations as captured through events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Artificial intelligence based systems (e.g., explicitly and/or implicitly trained classifiers), rules-based logic systems or other machine learning techniques can be employed in connection with performing inference and/or probabilistic determinations and/or statistical-based determinations as in accordance with one or more of the disclosed aspects.

According to an example, one or more aspects presented above can include making inferences pertaining to relationships between meeting participants. In accordance with another example, an inference can be made related to a meaning of an individual's gestures or behavior during a meeting. According to a further example, an inference can be made pertaining to a likelihood that a meeting will be productive based on the individuals invited to attend the meeting. It will be appreciated that the foregoing examples are illustrative in nature and are not intended to limit the number of inferences that can be made or the manner in which such inferences are made in conjunction with the various aspects described herein.

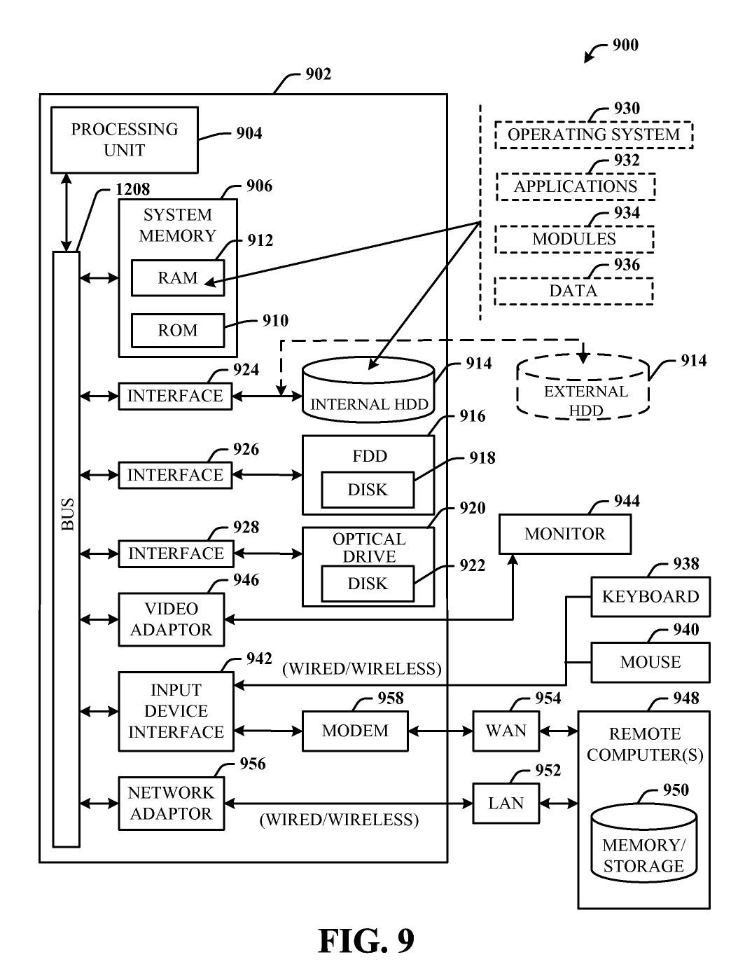

Referring now to FIG. 9, there is illustrated a block diagram of a computer operable to execute the disclosed architecture. In order to provide additional context for various aspects disclosed herein, FIG. 9 and the following discussion are intended to provide a brief, general description of a suitable computing environment 900 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the various aspects can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 through an interface, such as a video adapter 946. In addition to the monitor 944, a computer typically includes other peripheral output devices (not shown), such as speakers, printers, etc.

The computer 902 may operate in a networked environment using logical connections through wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 through the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

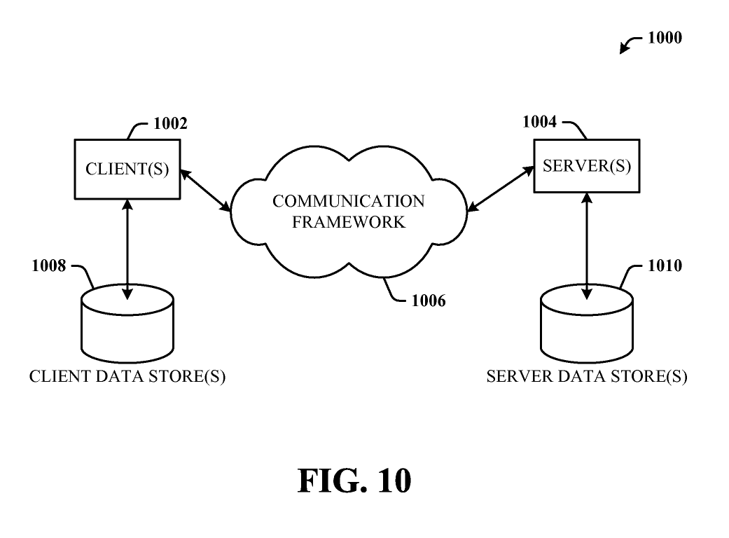

Referring now to FIG. 10, there is illustrated a schematic block diagram of an exemplary computing environment 1000 in accordance with the various aspects. The system 1000 includes one or more client(s) 1002. The client(s) 1002 can be hardware and/or software (e.g., threads, processes, computing devices). The client(s) 1002 can house cookie(s) and/or associated contextual information by employing the various aspects, for example.

The system 1000 also includes one or more server(s) 1004. The server(s) 1004 can also be hardware and/or software (e.g., threads, processes, computing devices). The servers 1004 can house threads to perform transformations by employing the various aspects, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated through a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” The term “or” as used in either the detailed description of the claims is meant to be a “non-exclusive or”.

The word “exemplary” as used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates interaction and collaboration between two or more individuals, comprising:
a collection component that gathers information relating to participants of a meeting;
a correlation component that determines a common relationship between at least two of the participants of the meeting; and
an output component that selectively presents the gathered information and the common relationship to one or more meeting participants.

2. The system of claim 1, the collection components receives an indication of the meeting and automatically gathers the information.

3. The system of claim 1, further comprising a monitoring component that observes actions in real-time.

4. The system of claim 1, the correlation component dynamically updates the common relationship as new information is gathered by collection component.

5. The system of claim 1, the collection component dynamically applies information presented during the meeting to a profile page.

6. The system of claim 1, the collection component further gathers information relating to a topic of the meeting and the correlation component determines a common relationship between the gathered information and one or more meeting participant.

7. The system of claim 1, further comprising a behavior component that observes an interaction between the meeting participants.

8. The system of claim 7, further comprising a ranking component that ranks a contribution of each meeting participant based in part on the interaction observed by the behavior component, the ranking is presented to at least one meeting participant by output component.

9. The system of claim 8, the ranking is presented as visual information.

10. The system of claim 7, further comprising an observance module that distinguishes between each meeting participant utilizing face-recognition technology in conjunction with a picture obtained by the collection component.

11. The system of claim 1, the output component presents the gathered information when a picture associated with at least one meeting participant is selected.

12. A method for increasing meeting participation through compilation of data, comprising:
monitoring gestures of attendees at a meeting;
evaluating the gestures to make a determination of a relevant participation level of each of the attendees;
ranking each of the attendees based on respective levels of participation; and
displaying the ranking for each of the attendees in real-time.

13. The method of claim 12, further comprising continuously updating a corresponding ranking as more gestures are monitored.

14. The method of claim 12, further comprising:
receiving an indication of the meeting;
gathering data associated with at least two attendees;
determining if there is a link between the at least two attendees based in part on the gathered data; and
displaying the gathered data and the link.

15. The method of claim 14, further comprising:
obtaining a picture that represents each of the at least two attendees; and
selectively displaying the gathered data and the link when the picture of one of the at least two attendees is chosen.

16. The method of claim 14, further comprising applying information obtained during the meeting and the ranking to a profile associated with one of the at least two attendees.

17. The system of claim 12, gathering data associated with at least two attendees comprises:
accessing a profile page that contains information authorized to be shared and information not authorized to be shared; and
ignoring the information not authorized to be shared.

18. The system of claim 12, ranking each of the attendees based on respective levels of participation comprises:
comparing contributions of each attendees; and
ranking each attendee as a function of a respective level of contribution by each attendee as compared to the other attendees.

19. A system for dynamically increasing meeting interaction through real-time feedback, comprising:
means for compiling information relating to at least two users;
means for analyzing the information to determine if there is a relationship between the at least two users;
means for displaying the information and the relationship;
means for monitoring interactions during a meeting between the at least two users; and
means for outputting the monitored interactions as a function of a level of participation for each of the at least two users.

20. The system of claim 19, further comprising:
means for ranking the level of participation for each of the at least two users; and
means for updating a source of the compiled information with the ranking and the monitored transactions.
